(19) United States
(12) Patent Application Publication
(10) Pub. No.: US 2021/0170309 A1
(43) Pub. Date: Jun. 10, 2021

(54) METHOD FOR CONTROLLING THE SEDIMENTATION OF A MINING DERIVATIVE

(71) Applicant: COATEX, Genay (FR)

(72) Inventors: Mehdi BOUZID, Sainte Foy Les Lyon (FR); Benoit MAGNY, Cailloux Sur Fontaines (FR); Jacques MONGOIN, Quincieux (FR)

(73) Assignee: COATEX, Genay (FR)

(21) Appl. No.: 15/734,335

(22) PCT Filed: Jun. 5, 2019
(86) PCT No.: PCT/FR2019/000092

§ 371 Date: Dec. 2, 2020

(30) Foreign Application Priority Data
Jun. 8, 2018 (FR) 1854991

(51) Int. Cl. B01D 21/01; B03D 3/06; C02F 11/147

(52) U.S. Cl. CPC B01D 21/01; C02F 2103/10; C02F 11/147; B03D 3/06

(57) ABSTRACT

The invention relates to a method for controlling the sedimentation of an aqueous mineral suspension of a mining derivative by means of the gravimetric concentration of the aqueous suspension in the presence of a flocculating agent and a polymer (P) which has a GPC-measured molecular mass Mw of between 2000 and 20000 g/mol and is prepared using at least one free radical polymerisation reaction of at least one anionic monomer (M).

The invention also relates to the resulting suspension, which has a Brookfield viscosity of less than 1 800 mPa·s or a yield point of less than 80 Pa.

The invention relates to a method for controlling the settling of an aqueous mineral suspension of a mining derivative by gravimetric concentration of the aqueous suspension in the presence of a flocculating agent and of a polymer (P) with a molecular mass Mw, measured by GPC, ranging from 2,000 to 20,000 g/mol, prepared by at least one radical polymerisation reaction of at least one anionic monomer (M).

The invention also relates to the suspension produced whose Brookfield viscosity is less than 1,800 mPa·s or whose flow threshold is less than 80 Pa.

The method according to the invention is used in a mining process involving at least one mineral deposit. These mining methods generally make it possible to obtain at least one useable metal from a metal ore. The metal ore also comprises a residue of this metal ore. The mining methods are usually implemented using water as a medium for processing or conveying the solids content. Therefore, the mining derivative is usually an aqueous mining derivative.

According to the invention, the fraction of the useable metal ore is a metal or several metals or a derivative of a metal or a derivative of several metals.

According to the invention, the aqueous metal ore residue thus results from at least one step in which the useable metal or a derivative of the useable metal is separated from a metal ore, in particular a metal ore produced by mining extraction.

When using the method according to the invention, an essential step consists of adding at least one polymer (P) to an aqueous mining derivative. This step therefore relates to the processing of a mining derivative. It can also relate to the processing of the useable metal ore. This step is therefore generally used in a mining method comprising various steps for processing the metal ore, metal or a derivative of a useable metal or for processing the metal ore residue.

Typically, mining methods comprise several steps for processing the metal ore, several steps for processing the useable metal or for processing the derivative of the useable metal, as well as several steps for processing the metal ore residue.

A mining method typically comprises one or more of the following steps:
crushing the metal ore,
grinding the metal ore, in particular dry grinding or wet grinding, usually in water,
separating, in particular by flotation, the useable metal or a derivative of the useable metal and the metal ore residue, particularly the aqueous residue,
purifying or enriching the useable metal or a derivative of the useable metal, in particular by flotation,
concentrating the metal ore residue or the useable metal or a derivative of the useable metal, for example by filtration, by settling, by gravity, by using a thickener, by flocculation,
partially separating the aqueous metal ore residue and part of the water,
conveying the metal ore, the aqueous metal ore residue or the useable metal or a derivative of the useable metal,
storing the metal ore, the aqueous metal ore residue or the useable metal or a derivative of the useable metal.

As the case may be, it is important to have effective methods that improve settling or that do not result in a decrease in the settling speed.

There are known methods for preparing an aqueous mineral suspension from an aqueous mining derivative, particularly the methods used to process, convey or store such a derivative.

Document EP 2686275 describes a method for controlling the rheology of an aqueous dispersion that comprises the addition of a natural polymer then the addition of a synthetic polymer to the aqueous system.

Document EP 1976613 relates to the concentration of an aqueous suspension of solid particles by adding an organic flocculant polymer and an agent chosen in the group comprising radical agents, oxidising agents, enzymes and radiation.

An article by Aixing Fan et al. (A study of dual polymer flocculation; Colloids and Surfaces A: Physicochemical and Engineering Aspects, 162, 2000, 141-148) describes the improvement in the flocculation of alumina particles with two different polymers.

Document EP 2771289 also relates to the concentration of an aqueous suspension of solid particles by introducing an organic flocculant polymer and adding a system of agents comprising an oxidising agent and a control agent.

Document WO 2014-019993 describes a method for concentrating an aqueous suspension of solid particles by adding an organic flocculant polymer and an active agent chosen among radical agents, oxidising agents and reducing agents.

To facilitate their handling, the known suspensions typically have a lower solids content. In fact, adding water may help to lower the viscosity or the flow threshold of these suspensions.

However, adding water leads to problems with water consumption, energy consumption or even problems with organising and storing the aqueous metal ore residues. Typically, settling is disrupted when water is added to an aqueous suspension of a mining derivative. It is therefore important to have methods for controlling the settling of an aqueous mineral suspension from an aqueous mining derivative with a high dry solids content.

It is also important to have such methods that make it possible to prepare stable suspensions, in particular at high dry solids contents. Likewise, it is important to have such methods which make it possible to prepare suspensions that are stable and in which the particles of dry solids content have a particle size distribution that is relatively coarse or is not very uniform.

Compatibility with the various constituents of the aqueous mineral suspensions prepared from an aqueous mining derivative is also an important property to look for, in particular compatibility with a flocculating agent that can be used to process the aqueous mining derivative, in particular compatibility with a polyacrylamide or a polyacrylamide derivative.

Likewise, it is important to be able to control the viscosity of aqueous mineral suspensions prepared from a mining derivative, in particular to make it easier to pump, stir or convey them.

Moreover, it is important to have methods that make it possible to control the flow threshold of the aqueous metal ore residue. It is particularly important to confer on an aqueous metal ore residue a minimum flow threshold that makes it possible to eliminate or reduce the risk of the solid portion of the residue settling in case there is no shearing or if there is slight shearing.

Reducing the consumption of water when processing aqueous mining derivatives should also be sought. Water recovery or recycling during the various steps in the mining methods is also to be preferred.

Both the amount of water that is separated or recycled and the quality of the separated or recycled water should be sought.

It is also important to be able to control the behaviour of the aqueous mineral suspensions prepared from an aqueous mining derivative in order to avoid problems with the processing, storage or conveying equipment. Indeed, this equipment can be damaged, jammed or clogged if there is a drift in or lack of control of the viscosity, flow threshold or settling of an aqueous mineral suspension prepared from an aqueous mining derivative. There is therefore a need for improved methods for controlling the settling of an aqueous mineral suspension from an aqueous mining derivative.

The method according to the invention provides a solution to all or part of the problems with the methods used in the prior art to control the settling of an aqueous mineral suspension from an aqueous mining derivative.

Thus, the invention provides a method for controlling the settling of an aqueous mineral suspension comprising at least one flocculating agent and with a dry solids content that is greater than 10% by weight of the suspension, chosen among:
an aqueous metal ore residue,
an aqueous suspension of metal ore and
an aqueous suspension of useable metal or of a useable metal derivative and derived from metal ore,

comprising the gravimetric concentration of the aqueous suspension in the presence of at least one polymer (P) with a molecular mass Mw, measured by GPC, ranging from 2,000 to 20,000 g/mol and prepared by at least one radical polymerisation reaction, at a temperature greater than 50° C., of at least one anionic monomer (M) comprising at least one polymerisable olefinic unsaturation and at least one carboxylic acid group or one of its salts, in the presence of at least one radical-generating compound chosen among hydrogen peroxide, benzoyl peroxide, acetyl peroxide, laurel peroxide, tert-butyl hydroperoxide, cumene hydroperoxide, ammonium persulphate, an alkaline metal persulphate, preferably sodium persulphate or potassium persulphate, an azo compound such as 2,2′-azobis(2-(4,5-dihydroimidazolyl)propane, 2,2′-azobis(2-methylpropionamidine) dihydrochloride, diazo-valeronitrile, 4,4′-azobis-(4-cyanovaleric) acid, AZDN or 2,2′-azobisisobutyronitrile and their respective combinations or associations with an ion chosen among Fe^{II}, Fe^{III}, Cu^{I}, Cu^{II} and mixtures thereof.

The method according to the invention makes it possible to control the settling of an aqueous mineral suspension with a dry solids content greater than 10% by weight of the suspension, the rheology of the suspension prepared for a dry solids content is greater than 10% by weight or greater than 15% by weight of the suspension.

Preferably, the suspension prepared according to the method according to the invention has a dry solids content of less than 20% by weight or less than 30% by weight or less than 35% by weight or even less than 40% by weight or less than 50% by weight.

Also preferably, the suspension prepared according to the method according to the invention has a dry solids content ranging from 10 to 50% by weight or from 10 to 40% by weight or from 10 to 35% by weight or from 10 to 30% by weight or from 10 to 20% by weight or ranging from 15 to 50% by weight or from 15 to 40% by weight or from 15 to 35% by weight or from 15 to 30% by weight or from 15 to 20% by weight or even ranging from 20 to 50% by weight or from 20 to 40% by weight or from 20 to 35% by weight or from 20 to 30% by weight.

The method according to the invention comprises the gravimetric concentration of the aqueous suspension. Preferably, this gravimetric concentration of the aqueous suspension comprises the separation of a supernatant phase and a settling bed.

According to the invention, these two phases which constitute these two fractions of the aqueous suspension vary mainly by their difference in dry solids content.

Such a difference leads to different properties for the supernatant phase and for the settling bed.

Preferably according to the invention, the gravimetric concentration of the aqueous suspension comprises the separation of a supernatant phase with a dry solids content of less than 5% by weight. Preferably according to the invention, the gravimetric concentration of the aqueous suspension comprises the separation of a settling bed with a dry solids content greater than 40% by weight.

More preferably according to the invention, the gravimetric concentration of the aqueous suspension comprises the separation of a supernatant phase with a dry solids content of less than 5% by weight and of a settling bed with a dry solids content greater than 40% by weight.

According to the invention, the supernatant phase and the settling bed have different rheological properties. In particular according to the invention, the settling bed has particular rheological properties.

Thus, in addition to settling, the method according to the invention makes it possible to control other essential properties of the aqueous suspension prepared. This method therefore makes it possible to control both the Brookfield viscosity and the flow threshold of the prepared suspension, in particular of the settling bed.

Preferably according to the invention, the gravimetric concentration of the aqueous suspension comprises the separation of a supernatant phase and of a settling bed that has:
a Brookfield viscosity, measured at 100 rpm and at 25° C., of less than 1,800 mPa·s or
a flow threshold measured at a temperature of 25° C. using a rheometer with imposed shearing, equipped with a bladed spindle, for a particular torsional loading, of less than 80 Pa or
a Brookfield viscosity, measured at 100 rpm and at 25° C., of less than 1,800 mPa·s and a flow threshold, measured at a temperature of 25° C. using a rheometer with imposed shearing, equipped with a bladed spindle, for a particular torsional loading, of less than 80 Pa.

According to the invention, the flow threshold, which characterises the flow resistance, is measured on a sample of an aqueous mineral suspension, particularly of an aqueous metal ore residue. The flow threshold is the shearing that must be applied to a suspension to cause it to flow. If the shearing is insufficient, the suspension deforms elastically whereas if the shearing is sufficient, the suspension can flow like a liquid.

According to the invention, the flow threshold expressed in Pascals (Pa) is measured at a temperature of 25° C. using a Brookfield DV3T rheometer with imposed shearing, equipped with a suitable spindle with blades. Without destroying the underlying structure, the bladed spindle is immersed into the material up to the first immersion mark. After a five-minute wait time, the measure is taken without pre-shearing at a speed of 0.5 rpm. This relatively low speed is preferred so as to minimise the inertia effect of the bladed spindle. The variation in torsional loading measured by the instrument in order to maintain a spin speed of 0.5 rpm is tracked over time. The value of the flow limit or flow threshold of the aqueous residue is indicated by the instrument when this variation is zero. According to the invention, the flow threshold is measured at a temperature of 25° C. using a rheometer with imposed shearing, equipped with a bladed spindle, for a particular torsional loading.

Preferably according to the invention, the settling bed has a flow threshold of less than 70 Pa or less than 60 Pa, more preferentially less than 50 Pa or less than 40 Pa, much more preferentially less than 30 Pa or less than 20 Pa.

Also preferably according to the invention, the settling bed has a flow threshold greater than 10 Pa, preferably greater than 12 Pa, much more preferably greater than 15 Pa.

Also preferably according to the invention, the settling bed has a flow threshold greater than 10 Pa, more preferentially greater than 12 Pa, much more preferentially greater than 15 Pa and less than 70 Pa or less than 60 Pa, more preferentially less than 50 Pa or less than 40 Pa, much more preferentially less than 30 Pa or less than 20 Pa.

According to the invention, the Brookfield viscosity is measured at 100 rpm and at 25° C., for example using a Brookfield DV3T rheometer. According to the invention, the Brookfield viscosity of the prepared suspension is generally less than 1,800 mPa·s. Preferably, the method according to the invention makes it possible to prepare a suspension with a viscosity of less than 1,500 mPa·s or less than 1,200 mPa·s. More preferably, the viscosity is less than 1,000 mPa·s or less than 900 mPa·s. Much more preferentially, the viscosity is less than 800 mPa·s or less than 700 mPa·s or even less than 500 mPa·s.

According to the invention, the amount of polymer (P) used may vary quite widely. Preferably according to the invention, the prepared suspension comprises from 0.01 to 2% by weight or from 0.01 to 1.8% or from 0.01 to 1.5% of polymer (P) (dry/dry relative to the ore residue). More preferentially, the prepared suspension comprises from 0.01 to 1.2% or from 0.01 to 1% or from 0.02 to 0.8% or from 0.03 to 0.5% or from 0.04 to 0.25% or from 0.04 to 0.15% by weight of polymer (P) (dry/dry relative to the ore residue).

The method according to the invention may use one or more polymers (P). Preferably, the suspension prepared thus comprises one, two or three different polymers (P). The method according to the invention may also comprise the further addition of at least one compound chosen among a lignosulphonate derivative, a silicate, an unmodified polysaccharide and a modified polysaccharide.

The method according to the invention comprises the addition of at least one polymer (P) to an aqueous mineral ore residue. Preferably, the metal ore is not an aluminium ore. Also preferably according to the invention, the metal ore is chosen among lithium, strontium, lanthanide, actinide, uranium, rare earth, titanium, zirconium, vanadium, niobium, chromium, molybdenum, tungsten, manganese, iron, cobalt, rhodium, iridium, nickel, palladium, platinum, copper, silver, gold, zinc, cadmium, tin and lead ores. More preferably according to the invention, the metal ore is chosen among uranium, molybdenum, manganese, iron, cobalt, nickel, copper, silver and gold ores. Much more preferably, it is a copper ore. It can also be a derivative of several useable metals comprising copper, zinc and cobalt.

According to the invention, the metal ore comprises at least one useable metal or at least one useable metal derivative obtained by separating all or part of the residue from the metal ore. Preferably according to the invention, the metal ore comprises a metal oxide, a metal sulphide or a metal carbonate.

According to the invention, the metal ore residue may comprise a certain residual amount of metal. Particularly, the metal ore residue may comprise a residual amount of metal of less than 2,000 g per tonne (dry/dry) relative to the amount of metal ore residue. This amount of metal in the metal ore residue can typically range from 10 to 2,000 g per tonne (dry/dry) or from 10 to 1,000 g per tonne (dry/dry), relative to the amount of metal ore residue.

When using the method according to the invention, the polymer (P) can be added during one or several steps in the mining process comprising the gravimetric concentration of the aqueous suspension.

Preferably according to the invention, the gravimetric concentration of the suspension is carried out using at least one device chosen among a conventional thickener, a high-density thickener, a high yield thickener.

Also preferably according to the invention, the polymer (P) is added before the gravimetric concentration of the suspension or during the gravimetric concentration of the suspension.

More preferably according to the invention, the polymer (P) is added at the same time as the addition of the flocculating agent, thus carried out simultaneously with the addition of the flocculating agent. Also more preferably according to the invention, the polymer (P) is added during the gravimetric concentration of the suspension and simultaneously with the addition of the flocculating agent.

Also more preferably according to the invention, the polymer (P) is added in the same spot as the addition of the flocculating agent, thus carried out in parallel to the addition of the flocculating agent. Also more preferably according to the invention, the polymer (P) is added during the gravimetric concentration of the suspension and in parallel to the addition of the flocculating agent.

The method according to the invention uses at least one particular polymer (P). It is prepared by a polymerisation reaction in the presence of at least one radical-generating compound chosen among hydrogen peroxide, benzoyl peroxide, acetyl peroxide, laurel peroxide, tert-butyl hydroperoxide, cumene hydroperoxide, ammonium persulphate, an alkaline metal persulphate, preferably sodium persulphate or potassium persulphate, an azo compound such as 2,2′-azobis(2-(4,5-dihydroimidazolyl)propane, 2,2′-azobis(2-methylpropionamidine) dihydrochloride, diazo-valeronitrile, 4,4′-azobis-(4-cyanovaleric) acid, AZDN or 2,2′-azobisisobutyronitrile, and their respective combinations or associations with an ion chosen among Fe^{II} Fe^{III}, Cu^{I}, Cu^{II} and mixtures thereof. Preferably, this polymerisation reaction does not use benzoyl peroxide.

In addition to this radical-generating compound, the polymerisation reaction can also be carried out in the presence of at least one compound comprising phosphorus in the oxidation I state, preferably a compound chosen among hypophosphorous acid (H₃PO₂) and a derivative of hypophosphorous acid (H₃PO₂), preferably a compound comprising at least one hypophosphite ion (H₂PO₂), more preferentially a compound chosen among sodium hypophosphite (H₂PO₂Na), potassium hypophosphite (H₂PO₂K), calcium hypophosphite ([H₂PO₂]₂Ca) and mixtures thereof.

Likewise, the polymerisation reaction can be carried out in the presence of at least one compound comprising phosphorus in the oxidation III state, preferably a compound chosen among phosphorous acid and a derivative of phosphorous acid, more preferentially a compound comprising at least one phosphite ion, in particular a compound chosen among sodium phosphite, calcium phosphite, potassium phosphite, ammonium phosphite, and combinations thereof.

The polymerisation reaction can also be carried out in the presence of at least one compound comprising a bisulphite ion, preferably a compound chosen among ammonium bisulphite, an alkaline metal bisulphite, in particular sodium bisulphite, potassium bisulphite, calcium bisulphite, magnesium bisulphite, and combinations thereof.

The polymerisation reaction can also be carried out in the presence of from 0.05 to 5% by weight, relative to the total amount of monomers, of at least one compound chosen among a xanthate derivative, a mercaptan compound and a compound of formula (I):

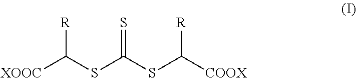

wherein:
   X independently represents H, Na or K and
   R independently represents a C₁-C₅-alkyl group, preferably a methyl group, particularly a compound of formula (I) which is disodic diisopropionate trithiocarbonate (DPTTC).

According to the invention, the polymerisation reaction is carried out at a temperature greater than 50° C. Preferably, the polymerisation reaction is carried out at a temperature ranging from 50 to 98° C. or from 50 to 95° C. or from 50 to 85° C.

A higher temperature, in particular above 100° C., may be used by adjusting the pressure of the reaction medium to prevent evaporation.

Preferably, the polymerisation reaction is carried out in water.

It can also be carried out in a solvent, alone or mixed with water, in particular an alcoholic solvent, particularly isopropyl alcohol. More preferably, it is carried out in water.

Advantageously, the polymer (P) used according to the invention has a molecular mass Mw, measured by GPC, ranging from 2,200 to 10,000 g/mol. Preferably, the polymer (P) used according to the invention has a molecular mass Mw ranging from 2,400 to 9,500 g/mol or from 2,400 to 8,000 g/mol, more preferentially from 2,400 to 6,500 g/mol. The polymer (P) used according to the invention is therefore not a flocculating agent.

According to the invention, the molecular mass Mw is determined by Gel Permeation Chromatography (GPC). This technique uses a Waters liquid chromatography apparatus equipped with a detector. This detector is a Waters refractive index detector. This liquid chromatography apparatus is equipped with a size exclusion column in order to separate the various molecular weights of the copolymers studied. The liquid elution phase is an aqueous phase adjusted to pH 9.00 using 1N sodium hydroxide containing 0.05 M of NaHCO₃, 0.1 M of NaNO₃, 0.02 M of triethanolamine and 0.03% of NaN₃.

According to a first step, the copolymer solution is diluted to 0.9% by dry weight in the dissolution solvent of the GPC, which corresponds to the liquid elution phase of the GPC to which is added 0.04% of dimethyl formamide which acts as a flow marker or internal standard. Then, it is filtered using a 0.2 μm filter. Then, 100 μL are injected into the chromatography instrument (eluent: an aqueous phase adjusted to pH 9.00 by 1N sodium hydroxide containing 0.05 M of NaHCO₃, 0.1 M of NaNO₃, 0.02 M of triethanolamine and 0.03% of NaN₃).

The liquid chromatography instrument has an isocratic pump (Waters 515) the flow rate of which is set to 0.8 mL/min. The chromatography instrument also comprises an oven which itself comprises the following system of columns in series: a Waters Ultrahydrogel Guard precolumn 6 cm long and 40 mm in inner diameter and a Waters Ultrahydrogel linear column 30 cm long and 7.8 mm in inner diameter. The detection system is comprised of a Waters 410 RI refractive index detector. The oven is heated to 60° C. and the refractometer is heated to 45° C.

The chromatography instrument is calibrated using powdered sodium polyacrylate standards of different molecular masses certified by the supplier: Polymer Standards Service or American Polymers Standards Corporation (molecular mass ranging from 900 to 2.25×10⁶ g/mol and polymolecularity index ranging from 1.4 to 1.8).

The polymer (P) used according to the invention can be completely or partially neutralised, in particular at the end of the polymerisation reaction.

According to the invention, the neutralisation of the polymer is carried out by neutralising or salifying all or part of the carboxylic acid groups present in the polymer.

Preferably, this neutralisation is carried out using a base, for example using a derivative of an alkaline metal or a derivative of an alkaline-earth metal.

The preferred bases are chosen among CaO, ZnO, MgO, NaOH, KOH, NH₄OH, Ca(OH)₂, Mg(OH)₂, monoisopropylamine, triethanolamine, triisopropylamine, 2-amino-2-methyl-1-propanol (AMP), triethylamine, diethylamine, monoethylamine. Particularly preferably, neutralisation is carried out using MgO, NaOH, KOH, Ca(OH)₂, Mg(OH)₂, alone or in combination.

According to the invention, the polymerisation reaction uses at least one anionic monomer (M) comprising at least one polymerisable olefinic unsaturation and at least one carboxylic acid group or one of its salts. Preferably, the anionic monomer (M) comprising at least one polymerisable olefinic unsaturation comprises one or two carboxylic acid groups, particularly a single carboxylic acid group. More preferably, it is chosen among acrylic acid, methacrylic acid, an acrylic acid salt, a methacrylic acid salt and mixtures thereof, much more preferentially acrylic acid.

Preferably, the polymerisation reaction uses 100% by weight of anionic monomer (M) or from 70% to 99.5% by weight of anionic monomer (M) and from 0.5% to 30% by weight of at least one other monomer.

Advantageously, the polymerisation reaction can thus also use at least one other monomer chosen among:
another anionic monomer, preferably a monomer chosen among acrylic acid, methacrylic acid, itaconic acid, maleic acid, maleic anhydride and mixtures thereof,
2-acrylamido-2-methylpropanesulphonic acid, a salt of 2-acrylamido-2-methylpropanesulphonic acid, 2-(methacryloyloxy)ethanesulphonic acid, a salt of 2-(methacryloyloxy)ethanesulphonic acid, sodium methallyl sulphonate, styrene sulphonate and combinations or mixtures thereof,
a non-ionic monomer comprising at least one polymerisable olefinic unsaturation, preferably at least one polymerisable ethylenic unsaturation and in particular a polymerisable vinyl group, more preferentially a non-ionic monomer chosen among styrene, vinyl caprolactam, the esters of an acid comprising at least one monocarboxylic acid group, in particular an ester of an acid chosen among acrylic acid, methacrylic acid and mixtures thereof, for example hydroxyethyl acrylate, hydroxypropyl acrylate, hydroxyethyl methacrylate, hydroxypropyl methacrylate, alkyl acrylate, in particular C₁-C₁₀-alkyl acrylate, preferentially C₁-C₄-alkyl acrylate, more preferentially methyl acrylate, ethyl acrylate, n-propyl acrylate, isopropyl acrylate, isobutyl acrylate, n-butyl acrylate, alkyl methacrylate, in particular C₁-C₁₀-alkyl methacrylate, preferentially C₁-C₄-alkyl methacrylate, more preferentially methyl methacrylate, ethyl methacrylate, n-propyl methacrylate, isopropyl methacrylate, isobutyl methacrylate, n-butyl methacrylate, aryl acrylate, preferably phenyl acrylate, benzyl acrylate, phenoxyethyl acrylate, aryl methacrylate, preferably phenyl methacrylate, benzyl methacrylate, phenoxyethyl methacrylate and
a monomer of formula (II):

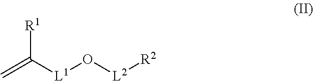

wherein:
   R¹ and R², identical or different, independently represent H or CH₃,
   L¹ independently represents a group chosen among C(O), CH₂, CH₂—CH₂ and O—CH₂—CH₂—CH₂—CH₂,
   L² independently represents a group chosen among (CH₂—CH₂O)ₓ, (CH₂CH(CH₃)O)_{y}, (CH(CH₃)CH₂O)_{z} and combinations thereof and
   x, y and z, identical or different, independently represent an integer or decimal comprised in a range from 0 to 150 and the sum of x+y+z is comprised in a range from 10 to 150.

Particularly preferably, the monomer of formula (IT) is such that:
R¹ represents CH₃,
R² represents H,
L¹ represents a C(O) group,
L² independently represents a combination of groups chosen among (CH₂—CH₂O)ₓ, (CH₂CH(CH₃)O)_{y}, (CH(CH₃)CH₂O)_{z} and
x, y and z, identical or different, independently represent an integer or decimal comprised in a range from 0 to 150 and the sum of x+y+z is comprised in a range from 10 to 150.

Preferably, the polymer (P) used according to the invention is a non-sulphonated polymer.

When preparing the polymer (P) used according to the invention, a separation step can also be carried out. According to the invention, the separation can be carried out after the full or partial neutralisation of the polymer (P). It can also be carried out prior to neutralising the polymer (P).

The aqueous solution of the fully or partially neutralised polymer (P) can be processed using the static or dynamic split methods known as such. To do so, one or more polar solvents is used, in particular from the group comprised of methanol, ethanol, n-propanol, isopropanol, butanols, acetone and tetrahydrofuran, thus resulting in a two-phase separation. During the separation, the least dense phase comprises the largest fraction of the polar solvent and the fraction of polymers of low molecular weight, and the densest aqueous phase comprises the fraction of polymers with the highest molecular weight. The temperature at which the polymer fraction selection is processed can influence the partition coefficient. It is typically comprised within a range of from 10 to 80° C., preferably from 20 to 60° C. During the separation, it is important to control the ratio of the amounts of dilution water and polar solvents.

When using a dynamic separation method, for example centrifugation, the ratios of the extracted fractions typically depend on the centrifugation conditions.

The selection of the fraction of the polymers can also be improved by re-processing the densest aqueous phase using a new amount of polar solvent, which can be different. It can also be a mixture of polar solvents. Lastly, the liquid phase obtained after processing can be distilled to eliminate the solvent(s) used in processing.

Particularly unexpectedly, the method according to the invention makes it possible to control the properties of the aqueous mineral suspension, in particular to control its settling, despite the presence of at least one flocculating agent in that suspension. The method according to the invention is effective in the presence of many types of flocculating agent. Preferably according to the invention, the flocculating agent is chosen among polyacrylamide, a polyacrylamide derivative.

The method of controlling the settling according to the invention makes it possible to prepare a suspension of aqueous metal ore residue comprising at least one polymer (P) that has particularly advantageous properties, in particular rheological properties that are particularly advantageous.

Thus, the invention also provides an aqueous mineral suspension comprising at least one flocculating agent and with a dry solids content that is greater than 10% by weight of the suspension, chosen among:
an aqueous metal ore residue,
an aqueous suspension of metal ore and
an aqueous suspension of useable metal or of a useable metal derivative and derived from metal ore,

comprising at least one polymer (P) with a molecular mass Mw, measured by GPC, ranging from 2,000 to 20,000 g/mol and prepared by at least one radical polymerisation reaction, at a temperature greater than 50° C., of at least one anionic monomer (M) comprising at least one polymerisable olefinic unsaturation and at least one carboxylic acid group or one of its salts, in the presence of at least one radical-generating compound chosen among hydrogen peroxide, benzoyl peroxide, acetyl peroxide, laurel peroxide, tert-butyl hydroperoxide, cumene hydroperoxide, ammonium persulphate, an alkaline metal persulphate, preferably sodium persulphate or potassium persulphate, an azo compound such as 2,2′-azobis(2-(4,5-dihydroimidazolyl)propane, 2,2′-azobis(2-methylpropionamidine) dihydrochloride, diazo-valeronitrile, 4,4′-azobis-(4-cyanovaleric) acid, AZDN or 2,2′-azobisisobutyronitrile, and their respective combinations or associations with an ion chosen among Fe^{II}, Fe^{III}, Cu^{I}, Cu^{II} and mixtures thereof.

Preferably, the aqueous mineral suspension according to the invention is obtained by gravimetric concentration of the aqueous suspension in the presence of at least one polymer (P) according to the invention.

Also preferably, the aqueous mineral suspension according to the invention is obtained when using the method according to the invention.

The particular, advantageous or preferred characteristics of the method according to the invention define suspensions according to the invention which are also particular, advantageous or preferred.

### EXAMPLES

The following examples illustrate the various aspects of the invention.

A polymer used in the method according to the invention is prepared.

Polymer (P1) is prepared by placing 212 g water and 0.08 g of iron sulphate heptahydrate into a one-litre glass reactor with mechanical stirring and oil bath heating.

303 g of acrylic acid at 100% by weight and 15 g of water are weighed into a 500 mL beaker fitted with a dosing pump.

25.6 g of sodium hypophosphite monohydrate diluted with 30 g of water are weighed into a 100 mL test tube fitted with a dosing pump.

21 g of hydrogen peroxide at 130 V and 35 g of water are weighed into a 100 mL test tube fitted with a dosing pump.

The reactor is heated to 95° C. and the monomer, the hypophosphite solution and the hydrogen peroxide solution are added in parallel in 120 min while keeping the temperature of the reaction medium at 95° C.

Lastly, the pumps are rinsed with water.

The medium is heated again for 60 min at 95° C.

The solution is then neutralised using 50% by weight of sodium hydroxide in water until it reaches pH 8 and then diluted to a solids content of 42% by weight. Polymer (P1) is obtained, with a molecular mass Mw, measured by GPC, of 4,500 g/mol.

The raw material used for this series of tests is an aqueous metal ore residue from a Chilean copper mine located in the north of the country. This is waste resulting from the separation of the ore containing the useable metal from the rock extracted from the mine.

This aqueous copper ore residue is in the form of a water-based suspension.

Various measures were taken beforehand on the aqueous residue in the absence of the polymer according to the invention:
particle size distribution using a Mastersizer 2000 laser granulometer (Malvern): D(80) of 243.1 μm and
solids content using a Mettler-Toledo dry balance: 63.5%.

A test is then performed to assess the effectiveness of the polymer on the settling of a suspension of aqueous copper ore residue when concentrating this residue by settling.

This settling test is carried out using a suspension with a solids content of 30% by weight. This suspension with a solids content of 30% by weight is prepared by diluting the aqueous suspension of residue with a solids content of 63.5% by weight.

A sample of suspension of aqueous copper ore residue at 30% by weight is transferred into a 500 mL beaker and then mechanically stirred with a Raynerie mixer. Stirring is carried out at 500 rpm.

Then, a polymer (P1) according to the invention is added at a dose of 0.05% by weight dry/dry relative to the dry residue and the mixture is left under stirring for 15 min.

The dispersed suspension is then incorporated into a 2-litre graduated test tube with a mechanical stirrer at 0.8 rpm.

A fixed dose of an acrylamide flocculating agent is incorporated at a dose equivalent to 12 g/T dry/dry of residue.

A test is carried out using the polymer (P1) and a comparative test is carried out without any polymer in the suspension.

After preparing a sample of the suspension, settling takes place gradually over time due to the phenomenon of flocculation of the solid particles comprised in the aqueous copper ore residue. These particles agglomerate to form heavier particle clusters. These clusters then settle faster. The aqueous supernatant phase is on the surface and the settled phase is at the bottom of the test tube.

At 25° C. and using a Brookfield DV3T viscometer with a suitable bladed module, the flow thresholds are measured on samples of the aqueous suspension of copper ore residue at 30% by weight of solids content.

The flow threshold (Pa) of the suspension is measured after it has been subjected to a very low shear rate (approximately 1 to 10 s⁻¹) (UN-YS). This corresponds to the flow threshold of the aqueous suspension of copper ore residue at the bottom of a thickener.

The flow threshold (Pa) of the suspension is also measured after it has been subjected to a very high shear rate (approximately 100 to 1,000 s⁻¹) (FS-YS).

This corresponds to the flow threshold of the aqueous suspension of copper ore residue at the outlet of a thickener.

The settling speed is also measured using the scale on the test tube and a stopwatch. This measure is performed by observing the separation of the supernatant water phase and settling phase. It is measured in cm/minute and then converted to meter/hour (m/h).

The results are shown in Table 1.

TABLE 1

| Suspension | UN-YS | FS-YS | Settling speed | % Solids content |
|---|---|---|---|---|
| Without additive | 400 | 41 | 7.6 | 64.6 |
| With polymer (P1) | 218 | 15 | 7.1 | 63.7 |

Moreover, a test is carried out using semi-industrial equipment. The settler is cylindrical with a clear wall.

It has a capacity of 30 L and is stirred by means of a low-power motor supplying a stirring speed of 1 rpm. The suspension of aqueous copper ore residue used has a solids content of 69% by weight dry/dry.

A fixed dose of an acrylamide flocculating agent is incorporated at a dose equivalent to 12 g/T dry/dry of residue.

The suspension is prepared in a similar manner to the previous preparation, at a solids content of 30% by weight dry/dry. The polymer dose remains the same. It is 0.05% by weight dry/dry. The polymer (P1) is introduced into the top of the thickener parallel to the feed shaft. The feed shaft is the area through which the aqueous ore residue is fed and the flocculant introduced.

The instrument used for the concentration of aqueous residue in the presence of a polymer according to the invention is a Plexiglass pilot thickener with a low-intensity stirrer that generates a stirring speed of 1 rpm. The flow threshold (Pa) of the suspension is measured after it has been subjected to a mean shear rate (approximately 10 to 100 s⁻¹) (MS-YS). This corresponds to the flow threshold at the conveying pump that sends the aqueous copper ore residue to the storage units.

The flow threshold (Pa) of the suspension is also measured after it has been subjected to a very high shear rate (approximately 1,000 to 10,000 s⁻¹) (HFS-YS). This corresponds to the flow threshold in the pipe located after the conveying pump at the outlet of a thickener and that conveys the aqueous copper ore residue to the storage units. The results are shown in Table 2.

The settling speed is also measured using the scale on the test tube and a stopwatch. This measure is performed by observing the separation of the supernatant water phase and settling phase. It is measured in cm/minute and then converted to meter/hour (m/h). It is comprised between 7 and 8 m/h.

TABLE 2

| Suspension | MS-YS | HFS-YS | % Solids content |
|---|---|---|---|
| Without additive | 175 | 50 | 69 |
| With polymer (P1 ) | 60 | 20 | 69 |

It can be seen that with the use of a polymer according to the invention, increasing the solids content of the aqueous suspension of copper ore residue at a thickener output does not result in a viscosity drift in the suspension.

This more consistent suspension can still be stirred using conventional equipment and is easier to handle, thus helping to prevent the risk of clogging the stirrers.

In addition, its improved solids content makes it possible to reduce water consumption relative to the amount of copper ore residue processed.

These tests also show that the presence of the polymer (P1) according to the invention significantly improves the flow threshold values of the aqueous suspensions of copper ore residue without disrupting the settling speed inside the concentration device.

Controlling the rheology at the outlet of a thickener makes it easier to discharge and convey this aqueous suspension to storage pools.

1. A method for controlling a settling of an aqueous mineral suspension comprising a flocculating agent and with a dry solids content that is greater than 10% by weight of the aqueous mineral suspension, selected from the group consisting of:
an aqueous metal ore residue,
an aqueous suspension of metal ore and
an aqueous suspension of useable metal or of a useable metal derivative and derived from metal ore,
the method comprising gravimetrically concentrating the aqueous suspension in the presence of at least one polymer (P) with a molecular mass Mw, measured by GPC, ranging from 2,000 to 20,000 g/mol and prepared by at least one radical polymerisation reaction, at a temperature greater than 50° C., of at least one anionic monomer (M) comprising a polymerisable olefinic unsaturation and a carboxylic acid group or one of its salts, in the presence of at least one radical-generating compound selected from the group consisting of hydrogen peroxide, benzoyl peroxide, acetyl peroxide, laurel peroxide, tert-butyl hydroperoxide, cumene hydroperoxide, ammonium persulphate, an alkaline metal persulphate, an azo compound and their respective combinations or associations with an ion selected from the group consisting of Fe^{II}, Fe^{III}, Cu^{I}, Cu^{II} and mixtures thereof.

2. The method according to claim 1, wherein the aqueous mineral suspension has a dry solids content:
greater than 15% by weight;
greater than 10% by weight and less than 20% by weight; and
ranging from 10 to 50% by weight.

3. The method according to claim 1, wherein the gravimetrically concentrating comprises separating a supernatant phase and a settling bed.

4. The method according to claim 1, wherein the gravimetrically concentrating comprises separating a supernatant phase and a settling bed that has:
a Brookfield viscosity, measured at 100 rpm and at 25° C., of less than 1,800 mPa·s or
a flow threshold measured at a temperature of 25° C. using a rheometer with imposed shearing, equipped with a bladed spindle, for a particular torsional loading, of less than 80 Pa or
a Brookfield viscosity, measured at 100 rpm and at 25° C., of less than 1,800 mPa·s and a flow threshold, measured at a temperature of 25° C. using a rheometer with imposed shearing, equipped with a bladed spindle, for a particular torsional loading, of less than 80 Pa.

5. The method according to claim 1, wherein the gravimetrically concentrating comprises separating a supernatant phase and a settling bed that has:
a flow threshold of less than 70 Pa;
a flow threshold greater than 10 Pa;
a flow threshold greater than 10 Pa and less than 70 Pa
a viscosity of less than 1,500 mPa·s.

6. The method according to claim 1, wherein the gravimetrically concentrating comprises separating a supernatant phase with a dry solids content of less than 5% by weight and a settling bed with a dry solids content greater than 40% by weight.

7. The method according to claim 1, wherein the aqueous mineral suspension comprises from 0.01 to 2% by weight of polymer (P) (dry/dry relative to the ore residue).

8. The method according to claim 1, further comprising adding one, two or three different polymer(s) (P) or adding at least one compound selected from the group consisting of a lignosulphonate derivative, a silicate, an unmodified polysaccharide and a modified polysaccharide.

9. The method according to claim 1, wherein:
the metal ore is selected from the group consisting of lithium, strontium, lanthanide, actinide, uranium, rare earth, titanium, zirconium, vanadium, niobium, chromium, molybdenum, tungsten, manganese, iron, cobalt, rhodium, iridium, nickel, palladium, platinum, copper, silver, gold, zinc, cadmium, tin and lead ores;
the metal ore comprises a metal oxide, a metal sulphide or a metal carbonate;
the metal ore residue comprises a residual amount of metal of less than 2,000 g per tonne (dry/dry) relative to an amount of metal ore residue.

10. The method according to claim 1, wherein:
the gravimetrically concentrating is carried out using at least one device selected from the group consisting of a conventional thickener, a high-density thickener, a high yield thickener, or in which:
the polymer (P) is added:
before the gravimetrically concentrating;
during the gravimetrically concentrating;
simultaneously with an addition of the flocculating agent;
in parallel to the addition of the flocculating agent;
during the gravimetrically concentrating and simultaneously with the addition of the flocculating agent, or
during the gravimetrically concentrating and in parallel to the addition of the flocculating agent.

11. The method according to claim 1, wherein:
the polymerisation reaction is carried out in the presence of at least one compound comprising phosphorus in the oxidation I state;
the polymerisation reaction is also carried out in the presence of at least one compound comprising a bisulphite ion;
the polymerisation reaction is carried out in the presence of at least one compound comprising phosphorus in the oxidation III state;
the polymerisation reaction is also carried out in the presence of from 0.05 to 5% by weight, relative to the total amount of monomers, of at least one compound selected from the group consisting of a xanthate derivative, a mercaptan compound and a compound of formula (I): 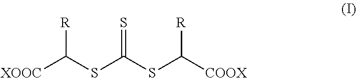
wherein:
X independently represents H, Na or K and
R independently represents a C₁-C₅-alkyl group, preferably a methyl group, particularly a compound of formula (I) which is disodic diisopropionate trithiocarbonate (DPTTC);
the polymerisation reaction is carried out at a temperature ranging from 50 to 98° C.;
the polymerisation reaction is carried out in water, in a solvent, alone or in a mixture with water;
the polymer (P) has a molecular mass Mw, measured by GPC, ranging from 2,200 to 10,000 g/mol;
the polymer (P) is completely or partially neutralised;
the polymerisation reaction uses:
100% by weight of anionic monomer (M) or
from 70% to 99.5% by weight of anionic monomer (M) and from 0.5% to 30% by weight of at least one other monomer.

12. The method according to claim 1, wherein the anionic monomer (M) comprises one or two carboxylic acid groups.

13. The method according to claim 1, wherein the polymerisation reaction also uses at least one other monomer selected from the group consisting of:
another anionic monomer;
2-acrylamido-2-methylpropanesulphonic acid, a salt of 2-acrylamido-2-methylpropanesulphonic acid, 2-(methacryloyloxy)ethanesulphonic acid, a salt of 2-(methacryloyloxy)ethanesulphonic acid, sodium methallyl sulphonate, styrene sulphonate and combinations or mixtures thereof;
a non-ionic monomer comprising at least one polymerisable olefinic unsaturation; and
a monomer of formula (II): 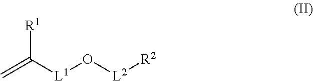
wherein:
R¹ and R², identical or different, independently represent H or CH₃,
L¹ independently represents a group selected from the group consisting of C(O), CH₂, CH₂—CH₂ and O—CH₂—CH₂—CH₂—CH₂,
L² independently represents a group selected from the group consisting of (CH₂—CH₂O)ₓ, (CH₂CH(CH₃)O)_{y}, (CH(CH₃)CH₂O)_{z} and combinations thereof and
x, y and z, identical or different, independently represent an integer or decimal comprised in a range from 0 to 150 and the sum of x+y+z is comprised in a range from 10 to 150.

14. The method according to claim 1, wherein the flocculating agent is selected from the group consisting of polyacrylamide and a polyacrylamide derivative.

15. An aqueous mineral suspension, comprising a flocculating agent and with a dry solids content that is greater than 10% by weight of the aqueous mineral suspension, selected from the group consisting of:
an aqueous metal ore residue,
an aqueous suspension of metal ore and
an aqueous suspension of useable metal or of a useable metal derivative and derived from metal ore,
comprising at least one polymer (P) with a molecular mass Mw, measured by GPC, ranging from 2,000 to 20,000 g/mol and prepared by at least one radical polymerisation reaction, at a temperature greater than 50° C., of at least one anionic monomer (M) comprising at least one polymerisable olefinic unsaturation and at least one carboxylic acid group or one of its salts, in the presence of at least one radical-generating compound selected from the group consisting of hydrogen peroxide, benzoyl peroxide, acetyl peroxide, laurel peroxide, tert-butyl hydroperoxide, cumene hydroperoxide, ammonium persulphate, an alkaline metal persulphate, an azo compound, and their respective combinations or associations with an ion selected from the group consisting of Fe^{II}, Fe^{III}, Cu^{I}, Cu^{II} and mixtures thereof.

16. The aqueous mineral suspension according to claim 15:
obtained by gravimetric concentration of the aqueous mineral suspension in the presence of at least one polymer (P).
